(19) United States
(12) Patent Application Publication
(10) Pub. No.: US 2014/0243133 A1
(43) Pub. Date: Aug. 28, 2014

(54) Cantilevered Boom Sprocket

(71) Applicant: The Charles Machine Works, Inc., Perry, OK (US)

(72) Inventors: Cody L. Sewell, Perry, OK (US); Michael D. Buck, Perry, OK (US); Blaine S. Talbot, Stillwater, OK (US)

(73) Assignee: The Charles Machine Works, Inc., Perry, OK (US)

(21) Appl. No.: 14/188,539

(22) Filed: Feb. 24, 2014

Related U.S. Application Data
(60) Provisional application No. 61/768,517, filed on Feb. 24, 2013.

(51) Int. Cl. F16H 55/30

(52) U.S. Cl. CPC F16H 55/30
USPC 474/152

(57) ABSTRACT

A trencher boom sprocket having a hub body rotatable at an engagement point by the shaft, a plurality of teeth supported on the hub body, an excluder ring supported within the hub body on the first side, at least one O-ring provided between the hub body and the excluder ring and applying a spring-load to the excluder ring, a cap supported within the hub at the second side to substantially seal the second side of the hub, a bearing disposed between the shaft and the hub between the engagement point and the second side, and a spacer disposed between the bearing and the cap.

### CROSS REFERENCE TO RELATED APPLICATION

This application claims the benefit of provisional patent application Ser. No. 61/768,517, filed on Feb. 24, 2013, the entire contents of which are incorporated herein by reference.

### FIELD

The present invention relates generally to the field of trenchers and trencher booms.

### SUMMARY

The present invention is directed to a trencher boom sprocket. The boom sprocket has a hub body rotatable at an engagement point by the shaft, a plurality of teeth supported on the hub body, an excluder ring supported within the hub body on the first side, at least one O-ring provided between the hub body and the excluder ring and applying a spring-load to the excluder ring, a cap supported within the hub at the second side to substantially seal the second side of the hub, a bearing disposed between the shaft and the hub between the engagement point and the second side, and a spacer disposed between the bearing and the cap.

### BRIEF DESCRIPTION OF THE DRAWINGS

FIG. 1 is a side view of a trencher boom.

FIG. 2 is a cross-section side view of a cantilevered trencher boom sprocket.

FIG. 3 is a perspective cross-section view of the boom sprocket of FIG. 2.

### DESCRIPTION OF THE PREFERRED EMBODIMENT

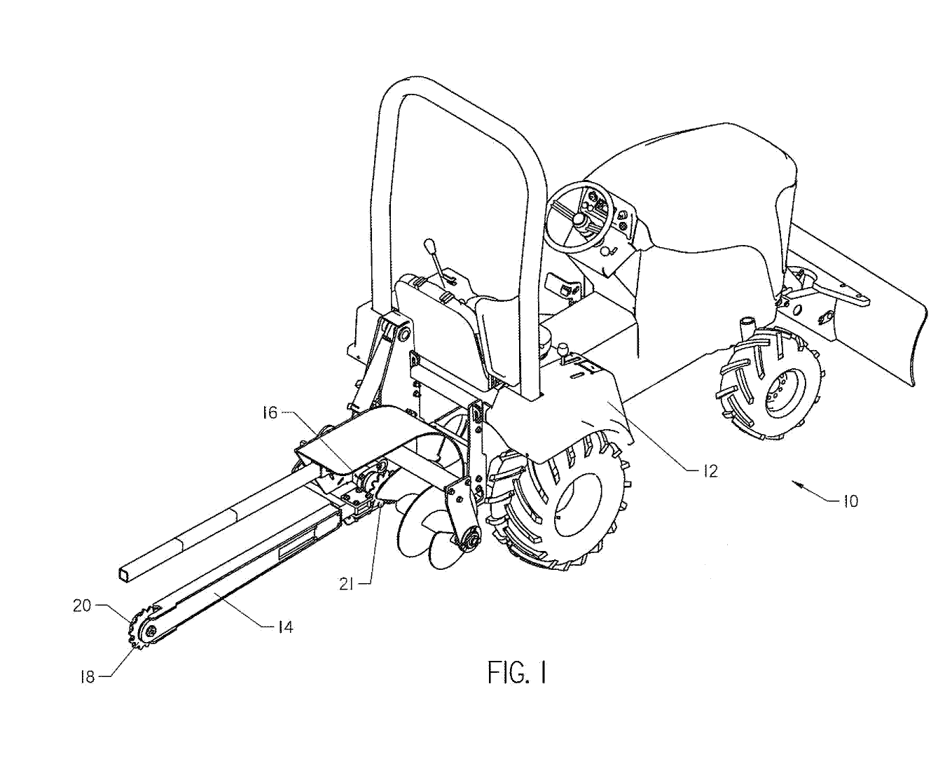

With reference to FIG. 1, shown therein is a trencher 10. The trencher 10 comprises a machine frame 12, a boom 14 pivotally attached to the machine frame 12, a digging chain (not shown) rotatable about the boom, and a cantilevered boom sprocket 18 comprising teeth 20 for engaging the chain at a distal end of the boom 14. The chain is driven around the boom 14 by a motor 16 connected to a drive sprocket 21. The trencher 10 may be used to dig a trench in a surface of the ground by lowering the boom 14 while the chain is rotating.

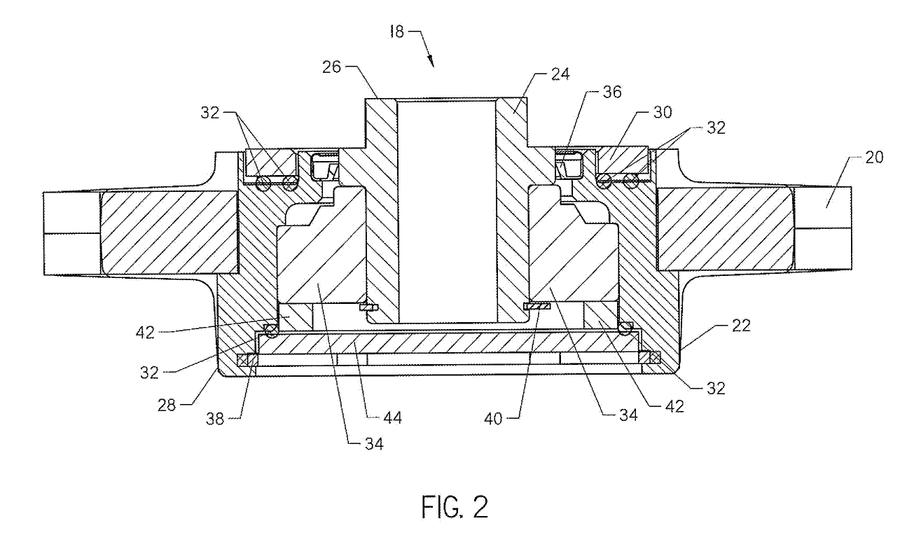

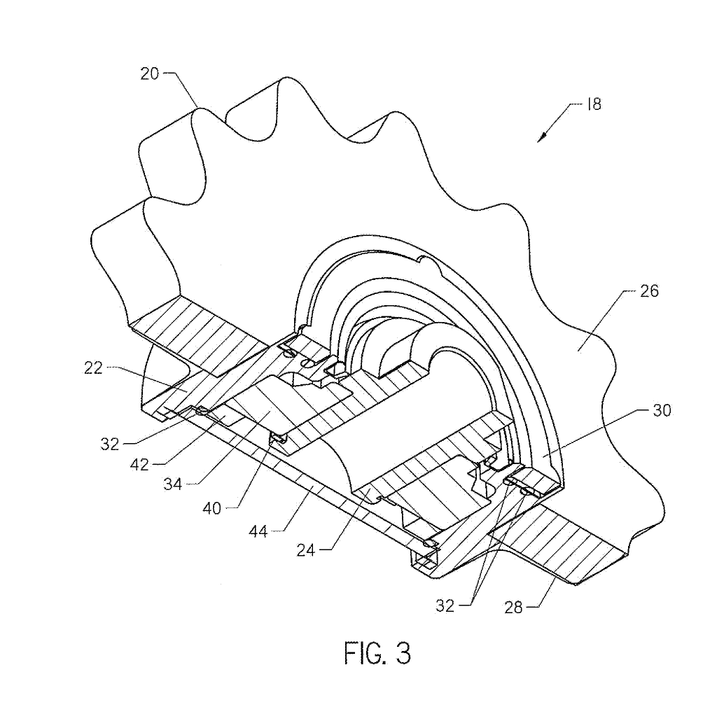

The cantilevered boom sprocket 18 is shown in more detail in FIGS. 2 and 3. The sprocket 18 comprises a sprocket hub 22 and a shaft 24. The shaft provides a rotatable attachment between the boom 14 (FIG. 1) and the chain 16. The sprocket hub 22 has a first side 26 and a second side 28. The shaft 24 enters the hub 22 on the first side 26. The shaft 24 engages the hub 22 at an engagement point 29 located proximate the first side 26. The sprocket hub 22 comprises an excluder ring 30, at least one O-ring 32, a bearing 34, an internal seal 36, an internal snap ring 38, an external snap ring 40, a spacer 42, and a cap 44. The excluder ring 30 seals the first side 26 of the hub 22 and is spring-loaded by the at least one O-ring 32. As shown, there are two O-rings 32. The excluder ring 30 may be made of an ultra high molecular weight polyurethane plastic, chrome plated steel, brass, or other high wear materials.

The bearing 34 provides spacing between the shaft 24 and the hub 22 such that frictional wear between the shaft and hub are reduced. The cap 44 is placed over the second side 28 of the hub 22. The spacer 42 is disposed between the bearing 34 and the cap 44 to prevent contact between the cap and the shaft 24. The internal seal 36 prevents dirt from penetrating the sprocket 18 on the first side 26. The internal snap ring 38 is placed in the sprocket hub 22 to retain the cap 44. The external snap ring 40 is placed in the shaft 24 to retain the bearing 34.

The O-rings 32, excluder ring 30, bearing 34, and hub 22 may be replaced during maintenance if any individual components of the sprocket 18 wear out

What is claimed is:

1. A trencher boom sprocket located at a distal end of a trencher boom, the sprocket having a first side and a second side, the trencher boom sprocket rotated about a shaft comprising:
a hub body rotatable at an engagement point proximate the first side by the shaft;
a plurality of teeth supported on the hub body;
an excluder ring supported within the hub body on the first side;
at least one O-ring provided between the hub body and the excluder ring and applying a spring-load to the excluder ring;
a cap supported within the hub at the second side to substantially seal the second side of the hub;
a bearing disposed between the shaft and the hub between the engagement point and the second side; and
a spacer disposed between the bearing and the cap.
